(19) United States
(12) Patent Application Publication
(10) Pub. No.: US 2018/0098147 A1
(43) Pub. Date: Apr. 5, 2018

(54) Speaker and Earphone

(71) Applicant: O2aid, Inc., Gumma (JP)

(72) Inventors: Akihiko Hosaka, Tokyo (JP); Yoshiyuki Watanabe, Gunma (JP)

(21) Appl. No.: 15/322,792

(22) PCT Filed: Jun. 9, 2016
(86) PCT No.: PCT/JP2016/067296

§ 371 Date: Dec. 29, 2016

(30) Foreign Application Priority Data
Jun. 11, 2015 (JP) 2015-118763

(51) Int. Cl. H04R 1/24; H04R 23/02; H04R 9/02

(52) U.S. Cl. CPC H04R 1/24; H04R 17/00; H04R 9/02; H04R 23/02

(57) ABSTRACT

The present invention provides a speaker that excels in frequency response in a high sound range and that can be produced stably, and an earphone in which the speaker is used. Provided are: a speaker 1 provided with a woofer 2 supported by a mold 23, a tweeter 3 in which a piezoelectric element 31 is attached to a diaphragm 32, and three or more supports 33 protruding from the peripheral edge of the diaphragm 32, the supports 33 being secured to the mold 23 and forming a gap between the diaphragm 32 and the mold 23; and an earphone in which the speaker 1 is used. The sound of the woofer 2 can be propagated from the gap.

### BACKGROUND OF THE INVENTION

### 1. Field of the Invention

The present invention relates to a speaker and an earphone using the speaker.

### 2. Description of the Related Art

A small-size speaker, that is used for an earphone or a headphone, usually includes a woofer and a tweeter that are arranged on the same axis (as disclosed in the prior art reference). Especially, a vibrating plate, with a piezoelectric element attached thereto, is used to compose the tweeter. Thus, the mold used for supporting the woofer is used in the tweeter to secure the component of the vibrating plate. The vibrating plate exists in the sound output of the woofer.

The above structure has the following problems. The vibrating plate interferes with the sound (waving air flow) from the woofer. Thus, the vibrating plate is provided with vent holes to circulate the air flow. However, it is necessary to shorten the size of the piezoelectric element or make the vibrating plate have an irregular shape so as to provide a determined area for mounting the vent holes, so that the sound characteristic is not good.

In addition, the vibrating plate has a circular shape and is secured on the mold, thereby easily producing resonance and anti-resonance in the inherent frequency due to the size of the vibrating plate, so that the frequency characteristic of the tweeter is uneven. Further, it is almost impossible to stabilize the sound characteristic and securing the vibrating plate under the condition of a low cost.

The prior art reference was disclosed in Japanese Publication No. 2004-147077.

### BRIEF SUMMARY OF THE INVENTION

The primary objective of the present invention is to provide a speaker that has a better frequency characteristic of high voice register and is made stably, and an earphone using the speaker.

In accordance with the present invention, there is provided a speaker comprising:
a woofer supported by a mold;
a tweeter including a vibrating plate and a piezoelectric element attached to the vibrating plate; and
three or more support portions protruding from a periphery or a vicinity of the vibrating plate and secured to the mold, while the support portions form a gap between the vibrating plate and the mold.

In such a manner, the sound of the woofer is transmitted from the gap. By design of the support portions, the transmission of the sound of the woofer is controlled spatially (such as the void width). In addition, the periphery of the vibrating plate presents a free end except the support portions, thereby decreasing the resonance and anti-resonance.

At this place, the term “ a periphery or a vicinity ” means the periphery of the inner side of the periphery of the vibrating plate, that is, a position which is closer to the periphery than to the gravity center of the vibrating plate.

In the speaker of the present invention:
at least one of the support portions extends through the mold, protrudes from the mold to a direction opposite to the vibrating plate, and is electrically conductive; and
the vibrating plate is electrically conductive.

In such a manner, the support portions function as conductors to apply a voltage on the piezoelectric element.

In the speaker of the present invention, viewing the vibrating plate and the piezoelectric element in the normal direction of the vibrating plate, the vibrating plate has a circular shape, and the piezoelectric element has a circular shape, while the piezoelectric element has a diameter more than 90% of that of the vibrating plate.

In such a manner, the piezoelectric element with a larger size is used to produce a larger sound pressure.

In the speaker of the present invention, the woofer is a dynamic type.

In such a manner, the woofer is a dynamic type which is available widely.

In the speaker of the present invention, the woofer produces sound in the mold opposite to the vibrating plate, and the mold has a sound guiding hole.

In such a manner, the woofer and the tweeter are arranged in the opposite sides.

In the speaker of the present invention, the woofer includes a piezoelectric element.

In addition, the woofer with a piezoelectric type is available.

In the present invention, an earphone using the speaker is provided.

In such a manner, the earphone has a high sound quality.

According the present invention, the sound output direction of the tweeter corresponds to the direction of the sound guiding hole to construct an earphone with a high voice register and a high sound quality.

### BRIEF DESCRIPTION OF THE SEVERAL VIEWS OF THE DRAWING(S)

FIG. 1 shows the structure of a conventional speaker in accordance with the prior art.

FIG. 2 shows the conventional speaker in accordance with the prior art.

FIG. 3 shows the structure of a speaker in accordance with the preferred embodiment of the present invention.

FIG. 4 shows the speaker in accordance with the preferred embodiment of the present invention.

FIG. 5 shows the frequency characteristic of the conventional speaker in accordance with the prior art.

FIG. 6 shows the frequency characteristic of the speaker in accordance with the preferred embodiment of the present invention.

FIG. 7 shows voltage being applied on the piezoelectric element.

FIG. 8 shows voltage being applied on the piezoelectric element.

FIG. 9 shows the structure of the speaker in accordance with another preferred embodiment of the present invention.

FIG. 10 shows the speaker in accordance with another preferred embodiment of the present invention.

FIG. 11 shows the speaker in accordance with another preferred embodiment of the present invention.

FIG. 12 shows securing structure of the support portions.

### DETAILED DESCRIPTION OF THE INVENTION

Embodiment 1 and individually designed Embodiments 2-4 are illustrated.

### Preferred Embodiment 1

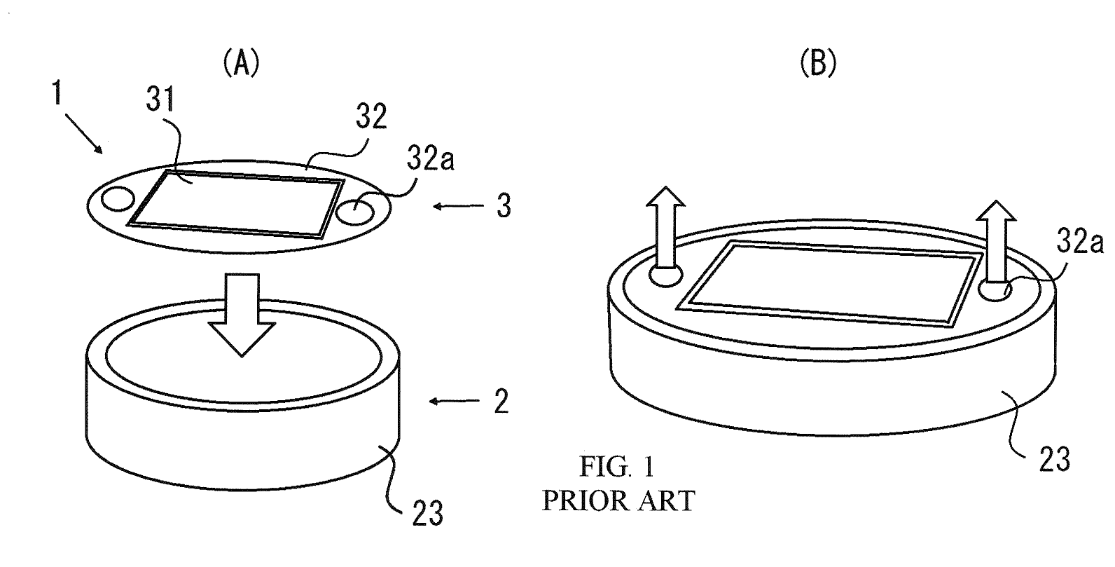

Referring to FIG. 1, a conventional speaker in accordance with the prior art is shown. As shown in FIG. 1(A), the conventional speaker 1 comprises a woofer 2 and a tweeter 3. The tweeter 3 includes a vibrating plate 32 and a piezoelectric element 31 attached to the vibrating plate 32. The vibrating plate 32 is secured to a mold 23 in the direction indicated by the arrow. However, the sound of the woofer 2 cannot be transmitted upward from the mold 23. Thus, holes 32a are formed in the vibrating plate 32 to transmit the sound of the woofer 2. As shown in FIG. 1(B), the sound of the woofer 2 is transmitted upward from the holes 32a in the direction indicated by the arrow.

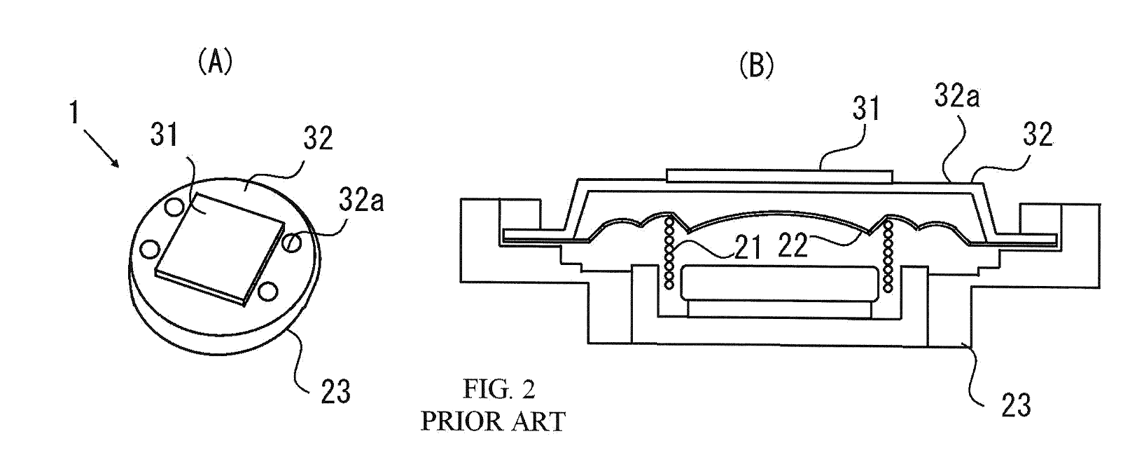

Referring to FIG. 2, the conventional speaker in accordance with the prior art is shown. As shown in FIG. 2(A), the conventional speaker has the holes 32a. The piezoelectric element 31 cannot occupy most of the area on the vibrating plate 32 to provide the space of the holes 32a, so that the piezoelectric element 31 on the vibrating plate 32 presents a square shape or a smaller circle. Thus, the sound pressure of the tweeter 3 is decreased, and the frequency characteristic produced by the interaction of the piezoelectric element 31 and the vibrating plate 32 is not good.

As shown in FIG. 2(B), the woofer 2 includes voice coils 21 and a voice basin (or frame) 22 both supported on the mold 23.

In the tweeter 3 consisting of the piezoelectric element 31 and the vibrating plate 32, the vibrating plate 32 is secured on the mold 23, and the size of the vibrating plate generates resonance and anti-resonance in the inherent frequency, so that the frequency of the tweeter is not flat.

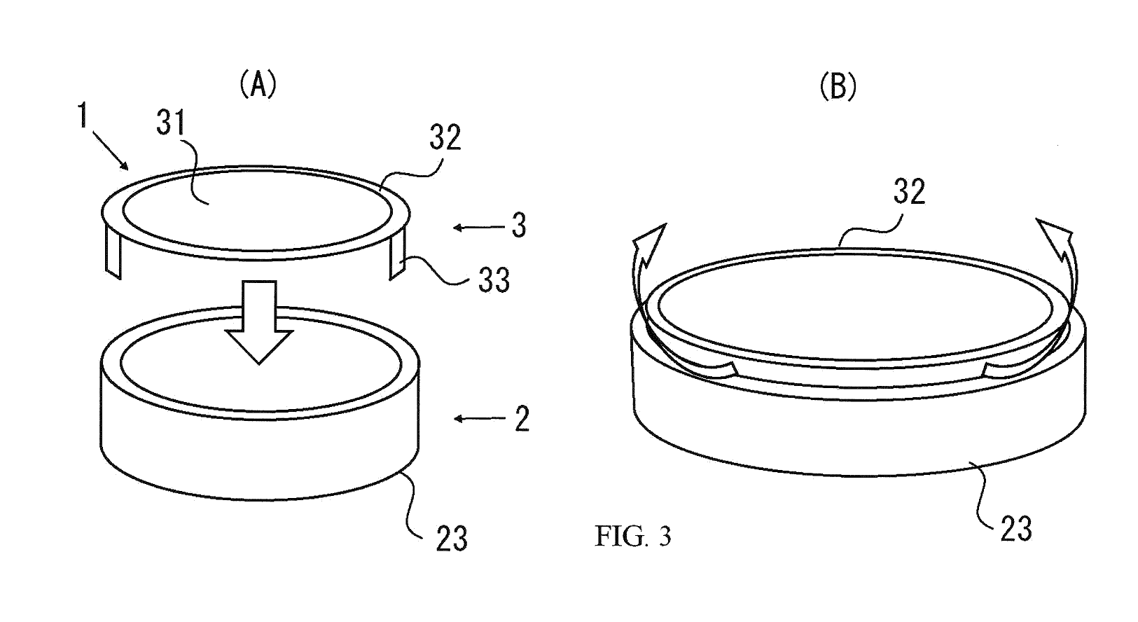

Referring to FIG. 3, a speaker in accordance with a preferred embodiment of the present invention is shown. As shown in FIG. 3(A) in contrast to FIG. 1, the vibrating plate 32 is provided with three or more support portions 33 instead of the holes 32a. The vibrating plate 32 is provided with three support portions 33. In addition, the number of support portions can be 4 or more. When the vibrating plate 32 is attached to the mold 23 in the direction indicated by the arrow, the support portions 33 are secured to the mold 23, and the vibrating plate 32 is not in contact with the mold 23. As shown in FIG. 3(B), a gap is created between the vibrating plate 32 and the mold 23 by the support portions 33, so that the sound of the woofer 2 is transmitted from the gap.

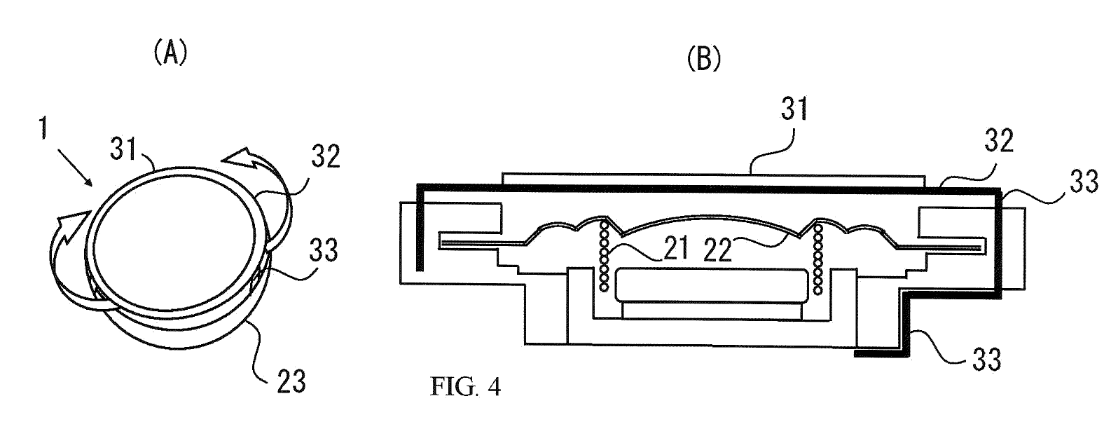

Referring to FIG. 4, the speaker in accordance with the preferred embodiment of the present invention is shown. As shown in FIG. 4(A) in contrast to FIG. 2, the piezoelectric element 31 almost covers the vibrating plate 32. If the vibrating plate 32 has a circular shape, the piezoelectric element 31 occupies an area of more than 90% of that of the vibrating plate. Thus, the sound pressure of the tweeter 3 is increased, and the frequency characteristic produced by the interaction of the piezoelectric element 31 and the vibrating plate 32 is better.

As shown in FIG. 4(B), the woofer 2 (the voice coils 21 and the voice basin 22 are the same) has a structure the same as that of FIG. 2. The support portions 33 of the tweeter 3 are secured on the mold 23, and the vibrating plate 32 is spaced from the mold, so that the size of the vibrating plate will not generate resonance and anti-resonance in the inherent frequency, and the frequency characteristic of the tweeter is almost flat.

In addition, one of the support portions 33 extends through the mold 23, and protrudes from the mold 23 in a direction opposite to the vibrating plate 32 (the lower part of the drawing). The support portions 33 and the vibrating plate 32 are electrically conductive, so that the support portions 33 function as conductors to apply a voltage on the piezoelectric element 31. The manner of applying the voltage is described additionally.

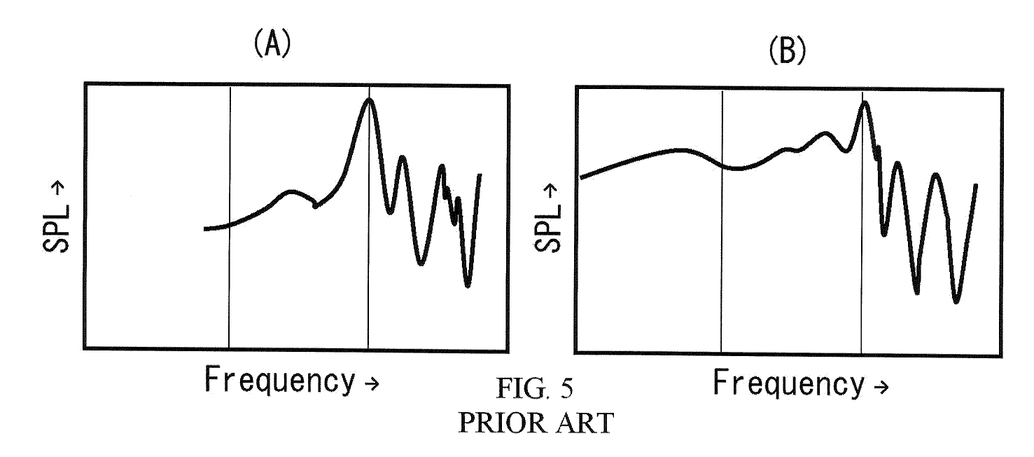

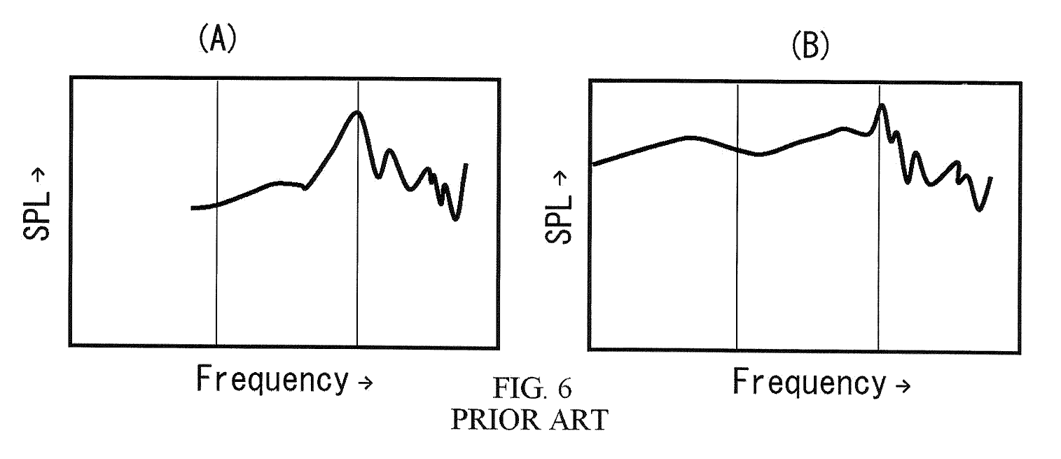

Referring to FIG. 5, the frequency characteristic of the conventional speaker is shown. As shown in FIG. 5(A), the frequency characteristic of the tweeter 3 is indicated. It is clear that, the frequency of the tweeter 3 is not flat, and the sound pressure at the high frequency is decreased. As shown in FIG. 5(B), the frequency characteristic of the conventional speaker 1 is indicated. It is clear that, the woofer 2 cannot compensate the unflat frequency of the tweeter 3, so that the whole high frequency characteristic of the conventional speaker 1 is bad. Referring to FIG. 6, the frequency characteristic of the speaker of the present invention is shown. As shown in FIG. 6(A), the frequency characteristic of the tweeter 3 is indicated.

It is clear that, the frequency of the tweeter 3 is almost even, and the sound pressure at the high frequency is increased. As shown in FIG. 6(B), the frequency characteristic of the speaker 1 of the present invention is indicated. It is clear that, the frequency characteristic at the high frequency of the speaker of the present invention is better than that of the conventional speaker 1 as shown in FIG. 5.

The manner of applying the voltage is described as follows. The support portions 33 and the vibrating plate are electrically conductive, and the support portions 33 function as conductors that are arranged on the piezoelectric element 31 corresponding to the side of the vibrating plate. If electrodes are arranged on the piezoelectric element 31 corresponding to the opposite side (the upper part of the drawing) of the vibrating plate, two electrodes are used to apply the voltage.

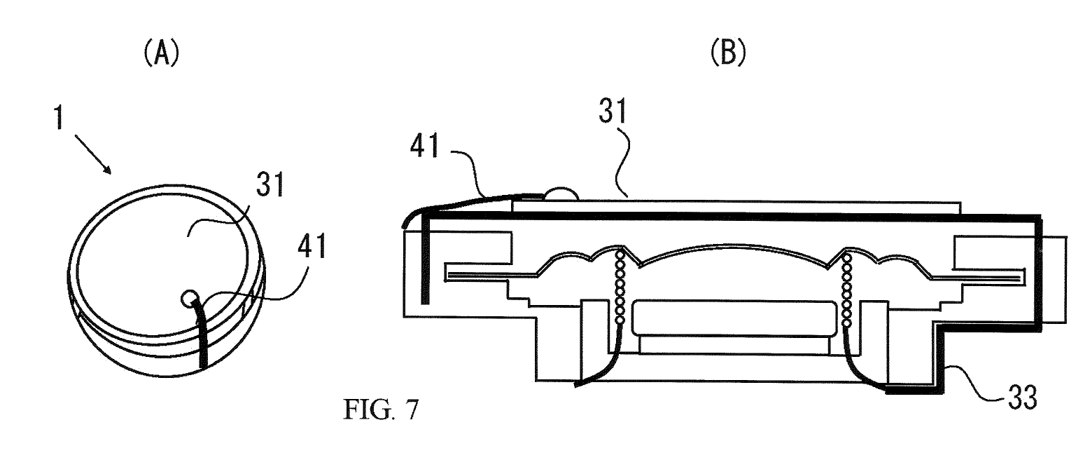

Referring to FIG. 7, the voltage is applied on the piezoelectric element 31. As shown in FIGS. 7(A) and 7(B), the electrodes are arranged on the piezoelectric element 31 corresponding to the opposite side (the upper part of the drawing) of the vibrating plate by solder material 41.

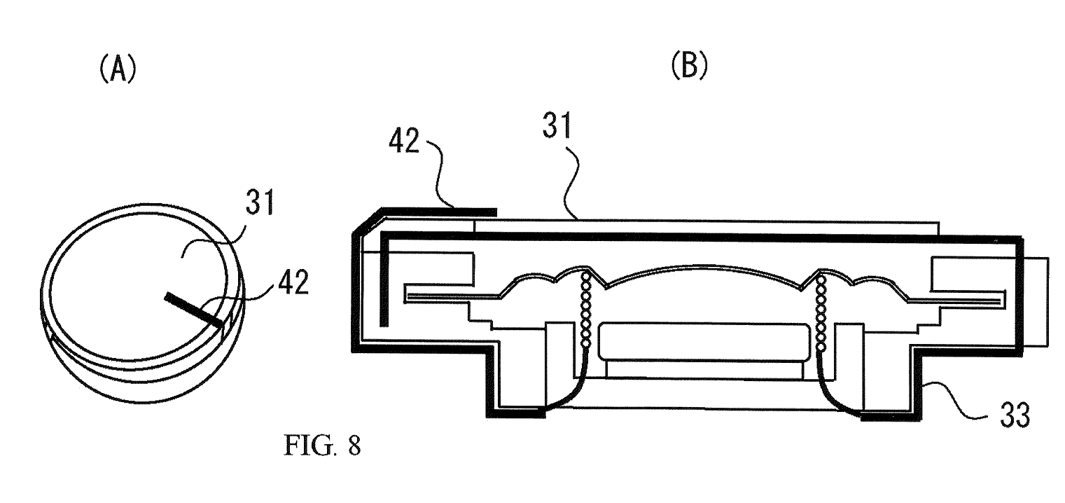

Referring to FIG. 8, the voltage is applied on the piezoelectric element 31. As shown in FIGS. 8(A) and 8(B), the electrodes are arranged on the piezoelectric element 31 corresponding to the opposite side (the upper part of the drawing) of the vibrating plate by a conducting resin 42.

The electrodes can be arranged on the piezoelectric element 31 corresponding to the opposite side (the upper part of the drawing) of the vibrating plate by other methods. Thus, it is easier to arrange the electrodes on the piezoelectric element corresponding to the opposite side of the vibrating plate 32 than corresponding to the side of the vibrating plate.

Accordingly, it is clear from the above illustrations that the speaker of the present invention (as this preferred embodiment) has better frequency characteristics, has better electrode calibration, and is produced easily.

In addition, the support portions 33 are secured to the mold 23 by riveting, inserting, bonding, embedding, integrally injection molding or other methods.

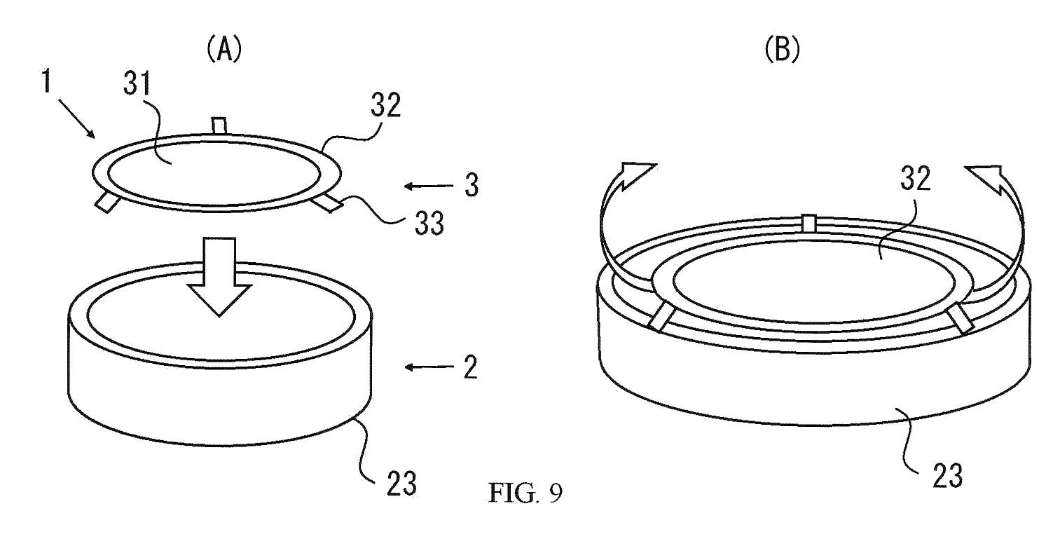

Although the support portions 33 protrude from the vibrating plate 32 and extend in the vertical direction of the drawing, as shown in FIG. 9, it may be arranged in the horizontal direction of the drawing.

### Preferred Embodiment 2

The speaker in accordance with another preferred embodiments 2 to 4 of the present invention is shown. By the support portions 33, the frequency characteristic of the speaker is enhanced, which is the same as the Embodiment 1 and will not be described in detail.

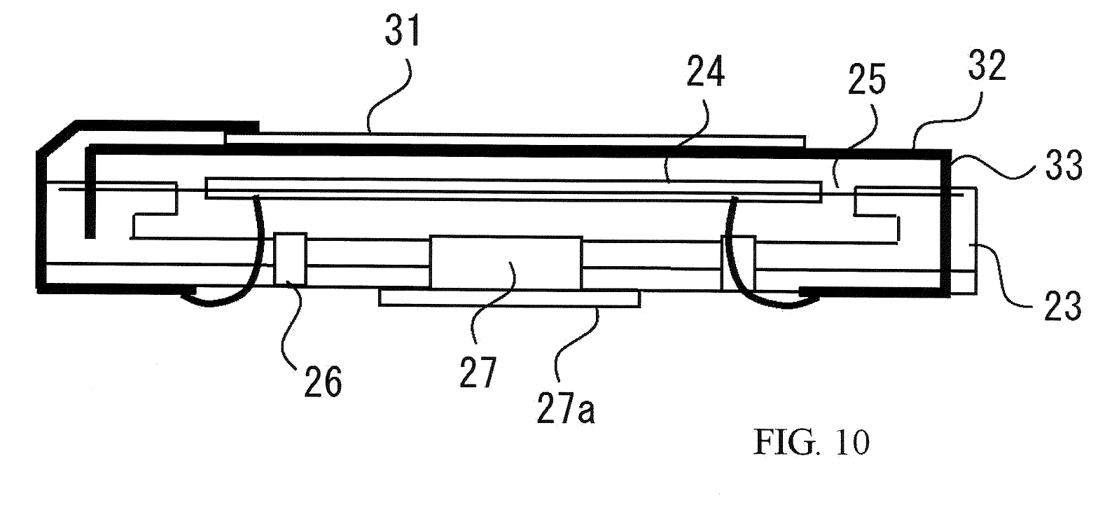

Referring to FIG. 10, the woofer 2 is not a dynamic type and includes a piezoelectric element 24 attached to a vibrating plate 25. The tweeter 3 has the same construction and includes the piezoelectric element 31, the vibrating plate 32 and the support portions 33, which is the same as the embodiment 1.

The piezoelectric element 24 is a vibrating body with a bimorph structure. The mold 23 has a back face provided with two holes 26 (the holes 26 of the mold 23 are sealed by a filler) to allow passage of connecting wires which are connected between the piezoelectric element and the mold. The back face of the mold 23 is provided with a cavity 27, and a grid film 27a is bonded onto the back face of the mold to cover the cavity, so that the woofer 2 has an even resonance frequency.

Therefore, by the woofer 2 of the piezoelectric type, the speaker 1 of the present invention can reduce the number of particles such as the voice coils, so that the frame has a thin size, and the speaker saves the electric energy.

### Preferred Embodiment 3

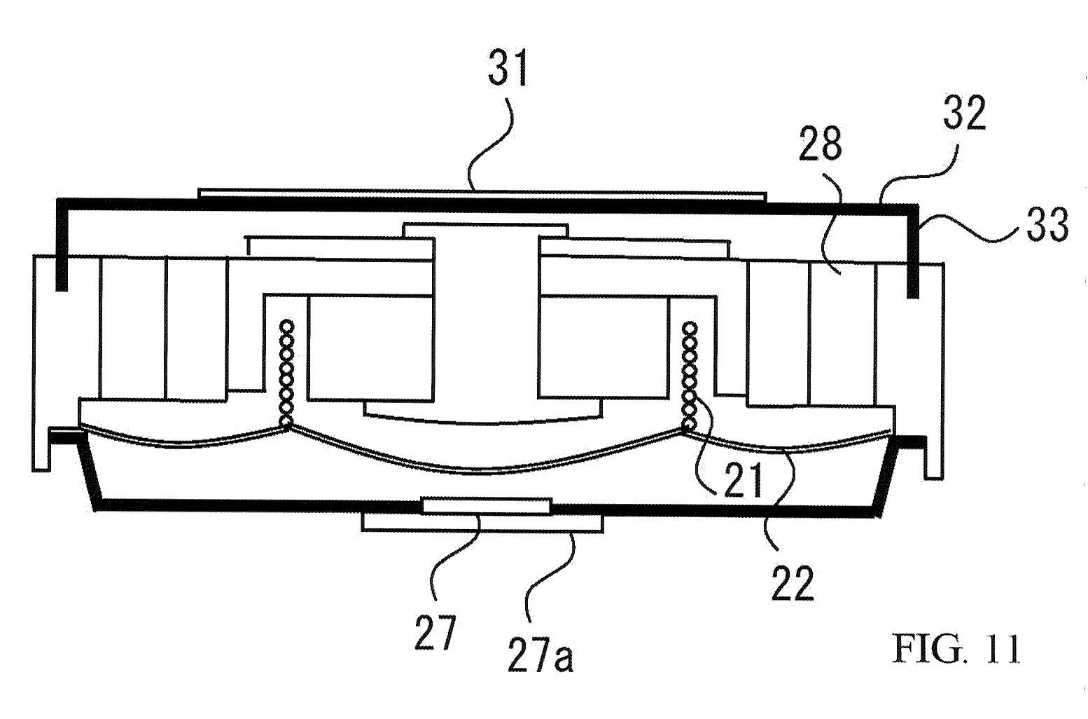

Referring to FIG. 11, the speaker in accordance with another preferred embodiment of the present invention is shown. The woofer 2 is arranged on the opposite side (the sound is generated from the lower part of the drawing) to the preferred embodiment 1. The woofer 2 (including the voice coils 21, the voice basin 22 and the mold 23) and the tweeter 3 (including the piezoelectric element 31, the vibrating plate 32 and the support portions 33) have the same construction as that of the embodiment 1.

The sound of the woofer 2 is transmitted from through holes 28. The woofer has an even resonance frequency by the cavity 27 and the grid film 27a, which is the same as the embodiment 2.

The tweeter 3 and the woofer 2 are arranged on the opposite sides of the mold 23, so that the constructions to secure the tweeter is worked easily. In addition, the diameter of the vibrating plate 32 is designed freely so that the frequency is adjusted easily.

Accordingly, it is clear from the above illustrations that the woofer 2 of the speaker 1 is arranged on the opposite side to enhance the freedom of working and design, thereby facilitating adjustment of the frequency.

### Preferred Embodiment 4

In the embodiment, the mold 23 is used to fix the support portions 33, and any one of the Embodiments 1-3 can use it additionally.

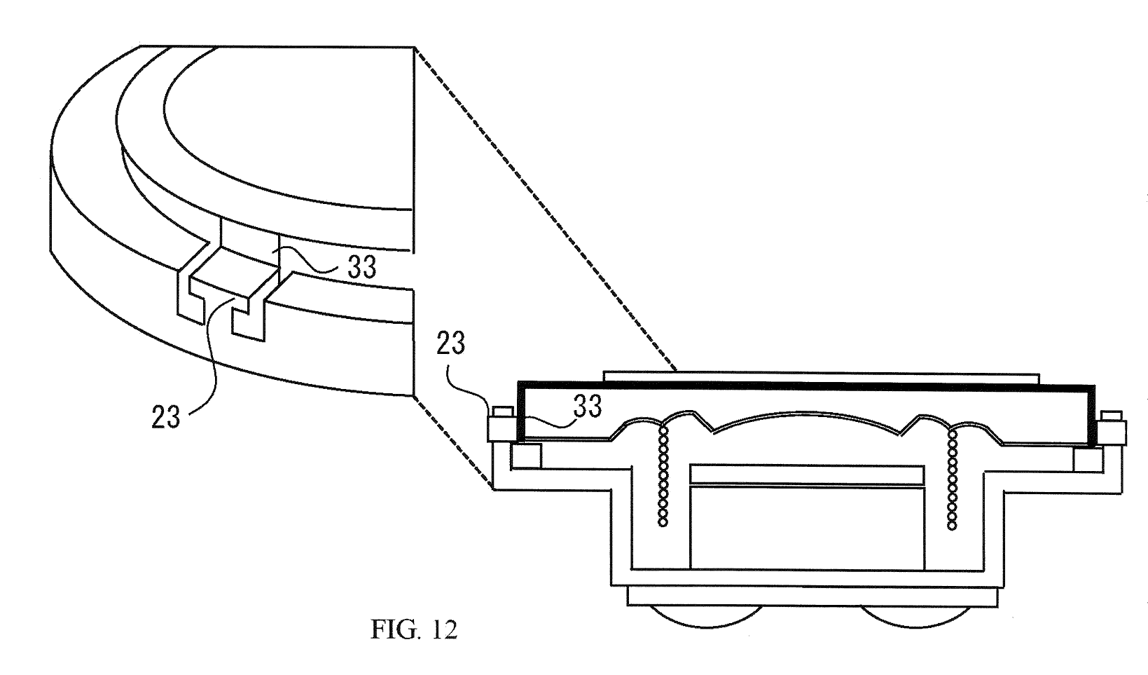

Referring to FIG. 12, the mold 23 is made of metal material. The mold 23 has an upper portion provided with grooves, and the support portions 33 (a portion) are secured in the grooves and are secured closely.

Accordingly, the speaker of the present invention has a simplified construction and can be mass produced.

### INDUSTRIAL APPLICABILITY

A speaker having a better frequency characteristic of high voice register, and an earphone using the speaker, are used by most of the sound machine manufacturers.

### SYMBOL ILLUSTRATION

1 speaker
2 woofer
21 voice coils
22 voice basin
23 mold
23a groove
24 piezoelectric element
25 vibrating plate
26 hole
27 cavity
27a grid film
28 through holes
3 tweeter
31 piezoelectric element
32 vibrating plate
32a hole
33 support portions
41 solder material
42 conducting resin

1. A speaker comprising:
a woofer supported by a mold;
a tweeter including a vibrating plate and a piezoelectric element attached to the vibrating plate; and
three or more support portions protruding from a periphery or a vicinity of the vibrating plate and secured to the mold;
wherein:
the support portions form a gap between the vibrating plate and the mold.

2. The speaker of claim 1, wherein:
at least one of the support portions extends through the mold, protrudes from the mold to a direction opposite to the vibrating plate, and is electrically conductive; and
the vibrating plate is electrically conductive.

3. The speaker of claim 1, wherein viewing the vibrating plate and the piezoelectric element in the normal direction of the vibrating plate, the vibrating plate has a circular shape, and the piezoelectric element has a circular shape, while the piezoelectric element has a diameter more than 90% of that of the vibrating plate.

4. The speaker of claims 1, wherein the woofer is a dynamic type.

5. The speaker of claim 1, wherein:
the woofer produces sound in the mold opposite to the vibrating plate; and
the mold has a sound guiding hole.

6. The speaker of claim 1, wherein the woofer includes a piezoelectric element.

7. The speaker of claim 1, further comprising an earphone using the speaker.

8. The speaker of claim 3, wherein the woofer is a dynamic type.

9. The speaker of claim 3, wherein:
the woofer produces sound in the mold opposite to the vibrating plate; and
the mold has a sound guiding hole.

10. The speaker of claim 3, wherein the woofer includes a piezoelectric element.

11. The speaker of claim 3, further comprising an earphone using the speaker.
